(19) United States
(12) Patent Application Publication
(10) Pub. No.: US 2017/0213241 A1
(43) Pub. Date: Jul. 27, 2017

(54) REACH AND FREQUENCY FOR ONLINE ADVERTISING BASED ON DATA AGGREGATION AND COMPUTING

(71) Applicant: Facebook, Inc., Menlo Park, CA (US)

(72) Inventors: Li Zhou, Campbell, CA (US); Goran Predovic, Redmont, WA (US); Ovidiu Popa, London (GB); Vikram Mukunda Rao Tankasali, London (GB); Liang Xu, Bellevue, WA (US)

(21) Appl. No.: 15/007,125

(22) Filed: Jan. 26, 2016

(51) Int. Cl. G06Q 30/02; G06Q 50/00

(52) U.S. Cl. CPC G06Q 30/0246; G06Q 50/01; G06Q 30/0201

(57) ABSTRACT

An audience analysis system determines and predicts reach and frequency information of online users. The system receives real-time ad impression data from ad publishers or other data providers as well as report requests from advertisers asking for the reach and frequency information. The reach and frequency information of online users describes characteristics of online users that are reached by the advertisers. Matched users and unmatched users are identified via online cookies. Atomic data units are generated to allow feature computation and reach prediction for online users in a more efficient way. Machine learning models are trained to help predict the reach and frequency of unmatched users and to generate reports. The audience analysis system provides the advertisers with the generated reports, responding to the report requests.

### BACKGROUND

This disclosure relates generally to online advertising, and more specifically to predicting on-demand reach and frequency of online audiences for advertisers of an online system.

Online advertisers are interested in predicting reach and frequency of online audience for advertising campaigns. Online advertisers provide advertisements to online users who receive various advertisements (i.e., advertising impressions) of ad campaigns associated with the advertisements. The reach and frequency of online audiences indicates the number of online users as a whole that are reached by the advertisers and the frequency of reaching those online users by the advertisers. The advertisers may also be interested in acquiring different kinds of user information about the online audiences. The user information includes geographical information (e.g., location) and demographical information (e.g., age, gender and interests), which is acquired by manually collecting online data. However, it is challenging to gather user information timely and accurately and to effectively predict audience reach based on the manually collected user information. In particular, it may be difficult to determine these users or to determine such users in a timely way, as the quantity of ad impressions may overwhelm the ability of a system to determine the information about the ad impressions in a timely way.

### SUMMARY

An audience analysis system aggregates advertising (ad) impression data and user feature data for online users receiving advertisements and predicts reach and frequency of the advertisements with improved accuracy and efficiency.

The audience analysis system receives requests from online advertisers for audience reach and frequency data for an advertisement or advertising campaign. The reach and frequency of an advertisement indicates the number of users reached and the frequency of reaching these users by ad publishers providing an advertiser's advertisements. The audience analysis system also receives real-time ad impression data that is associated with corresponding ad impression events from user devices, which may identify users via different kinds of tracking methods such as online cookies, IP addresses, device IDs, and other user identifiers. The ad impression data also includes identification attributes related to delivery of the ad, such as campaign ID, publisher ID, and site ID to identify information about the ad campaigns associated with the ad impression data. The online cookies or other user identifiers of the ad impression events for an ad campaign are used to identify matched users that have known additional feature data and unmatched users that do not have additional feature data. The additional feature data can include demographical information (e.g., age, gender, personal hobbies and interests) and geographical information (e.g., user location). The additional feature data can be identified by matching the identification attributes to various sources of user data, such as a tracking pixel for an ad network, a session identifier with a system having a user profile, or other systems. The additional feature data can also be provided by a social networking system that stores user information about its registered users. The additional feature data may also be generated based on a prediction of user attributes from other information known by a user. After identifying the matched users, the audience analysis system merges the additional feature data into the received ad impression data for the matched users, forming enriched user data. The user data of the users that were not matched via the identification attributes is referred to as unmatched user data.

To efficiently process requests for reach and frequency from advertisers for advertisements, the ad impression data for ad impressions is grouped into atomic data units for individual combinations of ad identification attributes over an amount of time. Each atomic data unit thus describes the enriched user data and unmatched user data for that combination of ad identification attributes. The atomic data unit thus describes characteristics of the users associated with the ad impressions over a period of time for the combination of identification attributes of the atomic data unit. Audience information of the online users including reach and frequency of users receiving an advertisement can be computed and determined based on the atomic data units with improved efficiency. To generate a report for an advertiser to describe the reach and frequency of an advertisement, the atomic data units fitting characteristics specified in the report request are retrieved and the reach and frequency for both matched and unmatched users can be determined from the retrieved atomic data units. As one example, the report for the advertiser may be determined by applying a trained model to the retrieved atomic data units to predict characteristics of the audience as a whole, including unmatched users. As another example, the audience characteristics for a report are determined for individual atomic data units prior to receiving a request for a report, such that the computation process for a report has already been performed at the atomic data unit level. The trained model is trained by correcting identified user information for matched users with panel data provided by panel data providers. The determined user information from the atomic data units indicate the characteristics of users interacting with the advertisements, for example, their demographical information (e.g., name, age, gender and personal hobbies) and their geographical information (e.g., country, city and town), the ad information associated with the users (e.g. ad content and publishers), the information about user devices (e.g., laptop and smartphones) and other related data.

### BRIEF DESCRIPTION OF THE DRAWINGS

FIG. 1 is a high-level block diagram of a system environment for an audience analysis system, according to one embodiment.

FIG. 2 is an example block diagram of an architecture of the audience analysis system, according to one embodiment.

FIG. 3 is an example data flow chart for the audience analysis system to determine and predict reach and frequency of online users, according to one embodiment.

FIG. 4 is a flowchart illustrating a process of reach and frequency determination and prediction, according to one embodiment.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED FIGURE DESCRIPTION

Various disclosed embodiments determine and predict reach and frequency of online audiences for online advertisers using data aggregation and feature computation. A real-time ad impression data stream associated with specific ad campaigns is received and users are identified by matching user log-in, cookie, or other identifying data to a user database, to identify matched and unmatched users receiving advertisements associated with the ad impression data. After data enrichment for the matched users, the ad impression data for portions of time is separated and aggregated into atomic data units, each having a specific combination of identification attributes of the ad impressions with specific values for the identification attributes. To predict reach and frequency of all the online users including both matched and unmatched users, multiple models are trained. Models may be used to predict and supplement user attributes. Additionally, known user information from panel data is used to correct user information when training the multiple models to correct user information and improve user attribute modeling. The models may also be used to predict audience data for the unmatched users, for example, to predict reach and frequency of the audience as a whole. Atomic data units are used for training multiple models and for predicting reach and frequency of the online users viewing an advertisement or viewing different advertisements associated with an ad campaign, which allows improved efficiency for feature computation and data prediction. Reports are generated based on the prediction results and report requests from advertisers. The reports are then provided to advertisers to evaluate the audiences for the advertisements.

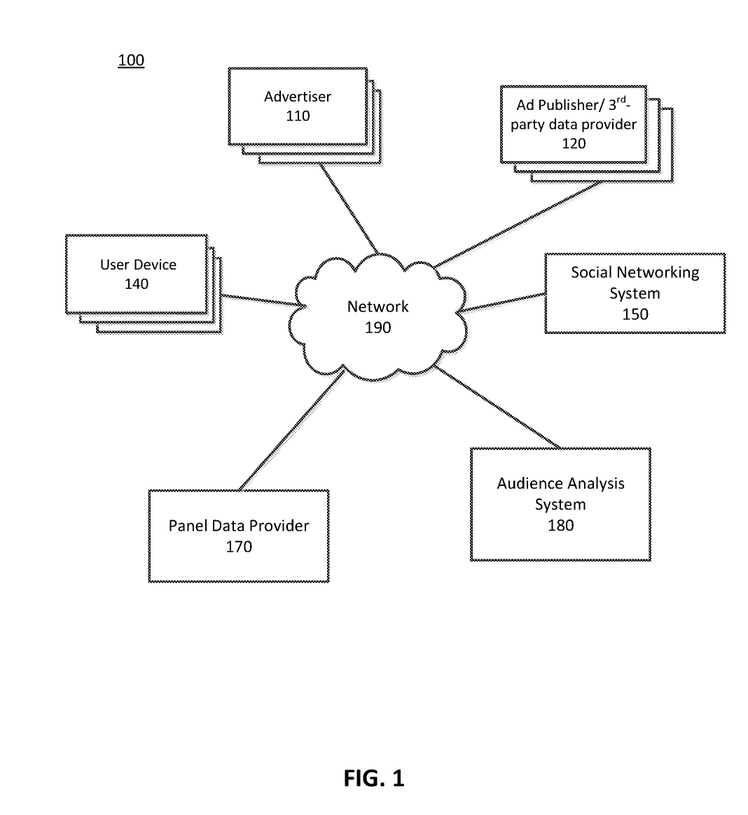

FIG. 1 is a high-level block diagram of a system environment 100 for an audience analysis system, according to one embodiment. In the embodiment of FIG. 1, the system environment 100 includes one or more advertisers 110, one or more advertising publishers or third party data providers 120, one or more user devices 140, a social networking system 150, a panel data provider 170, an audience analysis system 180 and a network 190. In alternative configurations, additional or fewer components may be included in the system environment. Likewise, the functions performed by the various entities of FIG. 1 may differ in different embodiments.

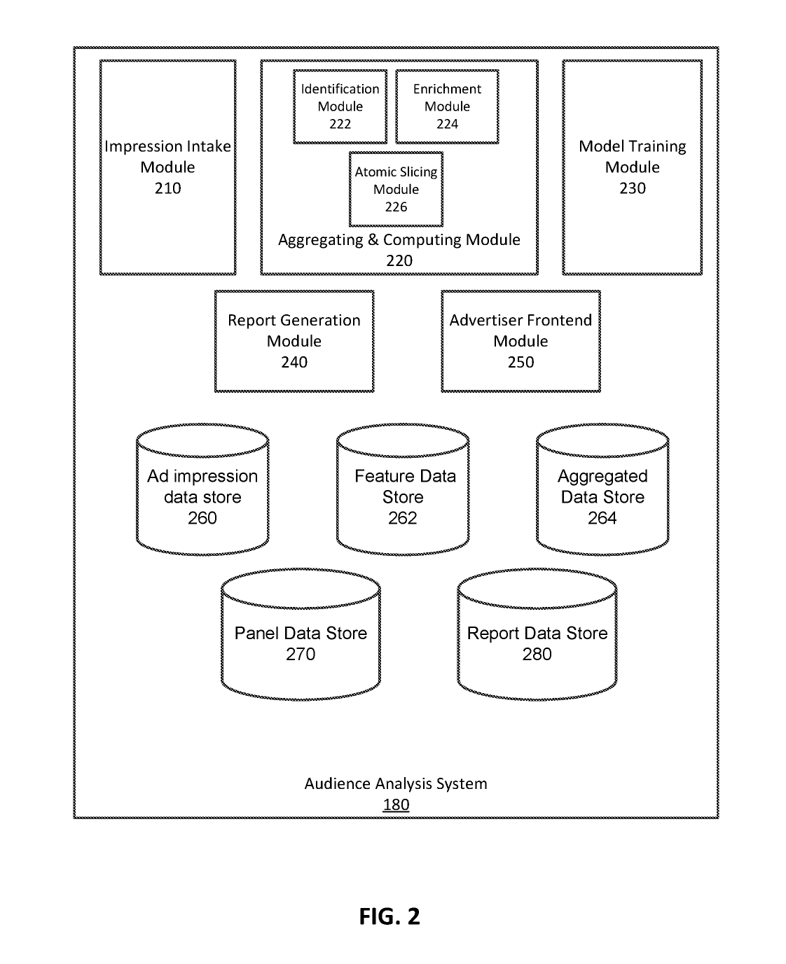

As more fully described below in FIG. 2, the audience analysis system 180 receives report requests from advertisers 110 for evaluation of audience reach and frequency of users that view or interact with advertisements provided by the advertiser. The audience analysis system 180 also receives ad impression data from user devices 140, ad publishers or third party data providers 120. The audience analysis system 180 identifies online audiences based on the ad impression data received from user devices 140, publishers or their party data providers 120 and known user data from the social networking system 150. The audience analysis system 180 matches users against known user characteristics to identify ad impressions with matched and unmatched users. The audience analysis system 180 then aggregates different kinds of user characteristics for the matched users. After determining the reach and frequency information of those matched users, the audience analysis system 180 trains models to predict reach and frequency of the audience as a whole, including the unmatched users, with aggregated data and panel data provided from panel data providers 170. The audience analysis system 180 generates different kinds of reports based on the prediction result in response to different requests received from advertisers 110.

In the embodiment of the system environment in FIG. 1, an ad publisher or a third party data provider 120 is a data source that provides ad impression data to the audience analysis system 180. An ad publisher 120 is an advertising platform that selects advertisements with different online content submitted by advertisers 110 and places the selected advertisements in advertising slots for presentation to users on user devices 140. In one embodiment, one or more advertisers 110 submit their advertisements to ad publishers 120 for display. The ad publishers 120 may select advertisements from these advertisers 110 and decide which advertisements to display to online users. As another type of data source, a third-party data provider 120 is a database that gathers and stores online ad impression data from ad publishers. Example ad publishers and third data providers 120 include search engines, social networking systems, news distribution systems, online forums and any other electronic system or webpage hosting platform that provides advertisements to users and gathers ad impression data from users. In one example, when users receive online content on the user device 140, the user device 140 may contact the audience analysis system 180 or social networking system 150 responsive to a tracking pixel in the advertisement. The audience analysis system 180 or the social networking system 150 may interrogate the user device 140 to receive the cookie and attempt to identify the user or user device 140 in a user database as further described below. Alternatively, user-identifying information may be provided by the ad publisher or third party data provider 120 for an ad impression. In another example, the ad publishers and third-party data providers 120 may provide ad impression data directly to the audience analysis system 180 without through the user devices 140.

A user device 140 is a computing device that is capable of receiving user input as well as of transmitting and/or receiving online data via the network 190. In the embodiment shown by FIG. 1, one or more user devices 140 can communicate within the network 190 and interact with the ad publishers or third party data providers 120 to receive and download advertisements from the publishers 120 and to provide ad impression data and user device information to the publishers or third party data providers 120. For example, a user device 140 may request an ad publisher 120 to download an advertisement on a webpage of that ad publisher. The user devices 140 also interact with the audience analysis system 180 to provide user data to the system.

In one embodiment, a user device 140 can be a conventional computer system, such as a desktop or a laptop computer. In another embodiment, a user device 140 can be a mobile telephone, a smartphone or a personal digital assistant (PDA). In one embodiment, the user device 140 interacts with other components in the network 100 through an application programming interface (API) running on a native operating system of the user device 140, such as IOS® or ANDROID™.

The social networking system 150 shown in FIG. 1 provides user identification for the audience analysis system 180 to identify individual users of the social networking system. For example, the online cookie that tracks an online user may indicate the user has a logged-in account to the social networking system 150, which helps identify the online user. For another example, the tracking pixel via which ad impression data is received is a tracking pixel implemented by the social networking system 150, which helps identify the online user. In the example above, after identifying the online user belongs to the social networking system 150, the user is categorized as a matched user. In addition to user information provided by the social networking system 150, the audience analysis system 180 may also have additional sources of user information. The social networking system 150 also provides additional user feature data (e.g., geographical and demographical data) for the audience analysis system 180 to enrich the ad impression data for the matched users. The social networking system 150 has a large user database that stores user data of its known registered users. The stored user data helps identify the registered users and provides user feature data. In one embodiment, example user data includes profile information provided by users on profile pages like demographical information such as age, gender, email address, mobile contact information, education history, work experience and etc. The user data may also include geographical information like location information such as the city and the country where a user is accessing the user device 140. The geographical information can be acquired, for example, by the IP address tracked by the social networking system 150. In another embodiment, user data stored in the user database in the social networking system 150 can be analyzed to provide other information such as personal hobbies or purchasing intentions on specific products. The analyzed data can be acquired by tracking user behavior on the social networking system 150 or by other identification methods.

This user behavior may also be tracked by an ad network, or by the audience analysis system 180. Users and user behaviors may be identified across different webpages and other online systems accessed by the user device 140 and may provide an additional source for user interest identification. In addition, users may be identified across more than one user device 140. The user may also be identified with a user of the social networking system 150 without a synchronized cookie, for example as described in U.S. patent application Ser. No. 14/642,256, filed Mar. 6, 2015, where is hereby incorporated by reference in its entirety.

A panel data provider 170 shown in FIG. 1 provides panel data about online users for the audience analysis system 180. The panel data is used to correct user information extracted from the ad impression data or the user information provided by the social networking system 150 to improve accuracy of the aggregated data maintained in the audience analysis system 180. In one embodiment, the panel data is used to correct reach and frequency information of the matched users when the audience analysis system 180 is training the multiple models. A panel data provider 180 maintains a set of data about known families, households, and other confirmed information about users, termed panel data. The panel data describes these confirmed user demographics and user characteristics. In the embodiment of FIG. 1, only one panel data provider 170 is shown in FIG. 1, but in alternative embodiments, multiple panel data providers 170 can be included in the system environment 110.

All the components described above communicate and interact with each other within the network 190. The network 190 may comprise any combination of local area and/or wide area networks, using both wired and/or wireless communication systems. In one embodiment, the network 190 uses standard communications technologies and/or protocols such as Ethernet, 802.11, worldwide interoperability for microwave access(WiMAX), 3G, 4G, code division multiple access (CDMA), etc. Example communication protocols include transmission control protocol/Internet protocol (TCP/IP), hypertext transport protocol (HTTP), file transfer protocol (FTP) and multiprotocol label switching (MPLS). Data exchanged over the network 190 can be represented for example, in the format of hypertext markup language (HTML) or extensible markup language (XML). Additional technologies may also be used in the network 190.

FIG. 2 is an example block diagram of the architecture of the audience analysis system 180, according to one embodiment. In the embodiment of FIG. 2, the audience analysis system 180 includes an impression intake module 210, an aggregating and computing module 220, a model training module 230, a report generation module 240, an advertiser frontend module 250, an ad impression store 260, a feature data store 262, an aggregated data store 264, a panel data store 270 and a report data store 280. As more fully described below, the aggregating and computing module 220 further includes an identification module 222, an enrichment module 224 and an atomic slicing module 226.

The ad impression data store 260 stores ad impression data received from user devices 140, the ad publishers or third party data providers 120. The ad impression data is received in the system 180 by the impression intake module 210 and is used for identifying ad impression events and determining aggregated user information. The ad impression data specifies ad impression events for specific ad campaigns and advertisements provided by the advertisers 110 and many various users that view or interact with the advertisements. The ad impression data also includes different kinds of user identifiers, such as a user ID (e.g., IP address, device ID, user account ID for other online applications or social networking systems), and identification attributes, such as a campaign ID, a publisher ID, a placement ID, a site ID, a platform ID or other identifiers for the ad impression events. A campaign ID identifies a single ad campaign in which multiple ad impression events are involved. The different ad impression events for the single ad campaign may be associated with a single user ID or with different user IDs. A publisher ID identifies an ad publisher 120 that displays to a user the advertisement that is associated with a specific ad impression event. A site ID identifies a website with a specific URL domain or a specific application on which the advertisement was displayed. The placement ID identifies a specific placement of the advertisement on a domain or application. The platform ID identifies a single user device (e.g., desktops, smartphones) accessing an ad impression event. Other identification attributes may include an IP address, user agent, and derived identification attributes. The derived identification attributes can be a combination of a plurality of individual identification attributes listed above. For example, a combination of IP address and account ID for a social networking system (e.g., the social networking system 150) can be a derived attribute.

The feature data store 262 stores user feature data that describes characteristics of users such as demographical and geographical information. In some embodiments, the user feature data can be extracted from user databases outside the audience analysis system 180, such as from the social networking system 150. In other embodiments, user features may also be identified from other data sources, such as via an advertising pixel that tracks user behavior across many web pages, and the user features may thus include inferred data or characteristics of the users from user behavior. The user feature data stored in the feature data store 262 is used for the aggregating and computing module 220 to provide additional user feature information such as geographical information and demographical information about online users. In one embodiment, the geographical information may indicate the location where a user is accessing the user device 140. In another embodiment, the geographical information may indicate the locations the user has been to. For example, the geographical information for a user indicates that the current location of the user is London and the user once visited Canada and China before and was born in California, US. The demographical information of a user may include age, gender, personal hobbies and interests, education history, working experience and other personalized information for that user. For example, the demographical information for the user in the example above may show that he is a boy with 17 years old who loves playing tennis and is interested in collecting tennis shoes with different brands. The user feature data including both geographical and demographical information is useful for the audience analysis system 180 to understand characteristics of an online user the system reached. For example, a tennis shoe advertiser selling tennis shoes in London may intend to target the user mentioned in the above example and the advertiser may request reports for online users who are interested in buying tennis shoes in London. These various user characteristics may be included as part of an audience report for the advertiser.

In one embodiment, user feature data is added only to matched users that are identified by the audience analysis system 180.

The aggregated data store 264 stores aggregated data that is generated by the aggregating and computing module 220 and may also be used by the model training module 230 to train multiple models and may be used by report generation module 240 for generating reports. The aggregated data refers to data that is aggregated and processed by the audience analysis system 180 to provide user information and advertising information about users reached by the system in a more organized way. In some embodiments, the aggregated data includes matched user data and unmatched user data. The matched user data and unmatched user data are aggregated user information for matched users and unmatched users before data enrichment and organization into atomic units. The aggregated data store 264 also includes enriched user data that is a combination of ad impression data and user feature data for the matched users. The enriched user data describes characteristics of the matched users including identification attributes (e.g., campaign ID, publisher ID and site ID) extracted from the ad impression data and demographical and geographical information extracted from feature data store 262. For unmatched users, the audience analysis system 180 cannot identify additional user information of them such as demographical and geographical information of the unmatched users, in which case information such as identification attributes that are extracted from the ad impression data associated with the unmatched users is stored and no user feature data is appended to form enriched user data for these users. The aggregated data store 264 further includes atomic data units for both unmatched and matched users. As more fully described below, the atomic data unit is a type of aggregated data describing a set of ad impressions and related audience with a specific combination of identification attributes. In one embodiment, the atomic data units for matched users include enriched user data, and the atomic data units for unmatched users include unmatched user data. The atomic data units may contain similar or same information with enriched user data and unmatched user data but in a different data structure. The atomic data units are generated by the atomic slicing module 226. In other examples, the atomic data units are further processed to identify predicted user characteristics and audience data.

More specifically, in one embodiment, an atomic data unit defines a combination of identification attributes with a specific atomic size, and an atomic data unit reflects advertising event data and user data for that combination of identification attributes. The specified combination of identification attributes is an atonic unit form. For a specified atomic unit form combining a set of identification attributes, each identification attribute is filled with a specific value and the whole combination of the set of identification attributes with the specified values represents a unique atomic unit data or a unique atom under this atomic unit form. For example, if two atomic data units (or two atoms) under a same atomic unit form have the same values for all the identification attributes specified by the atomic unit form, the two atoms represents a unique atomic data unit (or a unique atom). In contrast, two atomic data units (or two atoms) under a same atomic unit form with different values for at least one of the identification attributes, the two atomic data units (or the two atoms) represent two different atomic data units (or two different atoms).

As more fully described below, each identification attribute for an atomic data unit specifies an advertising dimension of the advertising impressions. Example advertising dimensions include campaigns, publishers, sites, device types, platforms, time range and etc.

Some user characteristics such as demographical information (age, gender) and geographical information (user location) can also be example advertising dimensions. For a given time span of ad impression events, the information of the ad impression events may be separated into atomic data units for each permutation of identification attributes of the advertisements. In this way, each atomic data unit represents one “slice” of the ad impression events. As one example, an atomic data unit can have the following combination of identification attributes and the following atomic unit form:
{Campaign, Publisher, Site, Placement, Platform, Hour}

For the atomic unit form example above, the combination of identification attributes includes campaign ID, publisher ID, site ID, placement ID, platform ID, and hour range. For example, {001, P01, S01, P01, M, June 5 1:00-2:00} and {001, P01, S01, P01, M, June 5 3:00-4:00} are two different atomic data units (or two different atoms) under this atomic unit form. These two atoms show information about the same campaign ID, publisher ID, site ID, placement ID and platform ID but different time ranges for the ad impression data. Thus, an atomic data unit represents a same set of identification attributes, and may be the smallest dividable type of information for which an advertiser may request a report. The atomic data unit includes the ad impression data as enriched with user information, and may include reach and frequency information for that atomic data unit. Compared with using the enriched user data without atomic unit forms, it is also more efficient for the model training module 230 to train machine learning models based on the atomic data units that represents a data structure that can be processed quickly in large-scale data computing. It is also more efficient for the report generation module 240 to predict characteristics of all the online users reached by the system 180 in response to report requests from advertisers 110 based on atomic data units. For report generating, it is also more efficient to query and extract user information for specific identification attributes that the advertisers 110 are interested in based on atomic data units.

The panel data store 270 stores panel data that is provided by the panel data provider 170. The panel data is used as ground truth value to correct training data and/or to improve the trained models with higher accuracy before the trained models are used by report generation module 240 to predict reach and frequency of unmatched users.

The report data store 280 stores report data that includes information about reports generated for advertiser requests and describes the reach and frequency of online audience viewing or interacting advertisements provided by the advertisers 110. The report data is generated from the report generation module 240 and is used for the advertiser frontend module 250 to present reports in response to report requests from advertisers 110. In one embodiment, the report data indicates the number of the online users that are reached by the audience analysis system 180 and the frequency of those users being reached by the system. In response to a report request from an advertiser 110, the report data may also include the number of the online users that are reached by the advertiser and the frequency of those users being reached by the advertiser. The report data also includes the characteristics of both the matched users and the unmatched users that are identified by the identification module 222. Example characteristics include geographical information (e.g., user location) and demographical information (e.g., age, gender, personal hobbies and interests).

As described above, the report data includes information about reach and frequency for both matched users and unmatched users with specified dimension levels. In various embodiments, the selection of dimension levels representing the report data may be determined by the audience analysis system 180 and/or be determined by the report requests received from the advertisers 110. As one example, an advertiser 110 may request a report that presents reach and frequency information of online users with three dimensions (e.g., campaign ID, publisher ID and time range). In this example, in response to the report request, the report data may have three dimensions of information indicating ad campaigns that are associated with the online users, ad publishers that delivered the advertisements to the users, and the time range that the information about the users (ad impression data) is gathered. As another example, in response to a request for reach and frequency information about all users for a same ad campaign and with several specific publishers, the report data may show data entries of all users (e.g., both matched and unmatched users) associated with a same campaign ID and grouped by specific publisher IDs (e.g., Publisher A, Publisher B and Publisher C). The data entries may have demographic and geographic information for all qualified users who are associated with the same campaign ID and specific publisher IDs above.

The impression intake module 210 receives and gathers raw ad impression data from ad publishers and/or third party data providers 120. In one embodiment, the raw ad impression data is received in real-time as ad impressions are provided to users. To provide the real-time data, the ad publisher 120 may contact the audience analysis system 180 and report to the system when an advertisement has been provided, or the user device 140 may contact the audience analysis system 180 via a tracking pixel in the advertisement. When the advertisement is received, the ad impression data may include user identifiers and advertising identification attributes associated with the advertisement and associated with the user viewing or interacting with the advertisement. The ad impression data is provided to the aggregating and computing module 220 for determining further user information about the ad impression.

The aggregating and computing module 220 aggregates and computes the raw data extracted from raw data store 260 and the user feature data extracted from the feature data store 262 to form aggregated data that is stored in the aggregated data store 264. As described above, the aggregated data includes enriched user data, unmatched user data and atomic data units.

In the embodiment of aggregating and computing module 220 shown in FIG. 2, the identification module 222 identifies matched and unmatched users based on the raw ad impression data received by the impression intake module 210 and user data stored in user databases of the social networking system 150. The matched users are identified users reached by the system 180 for which additional feature data associated with the identified users is available from other data sources (e.g., the social networking system 150). In one embodiment, the user ID included in the raw ad impression data helps identify the users associated with the ad impression data. In one embodiment, the identification module 222 uses online cookies that track and record user online behavior (e.g., viewing history of different websites, logging history of different online applications or social networking systems) to identify whether a user belongs to a registered user of the social networking system 150. If the user belongs to a registered user of the social networking system 150, the user is a matched user. If the user does not belong to a registered user of the social networking system 150 or the user is an unknown online user who cannot be identified by any data record (e.g., demographical or geographical information) in the audience analysis system 180, the user is an unmatched user. In one embodiment, the matched users and unmatched users are decided under one same ad campaign by information extracted from the ad impression data that are associated with a same ad campaign. For example, for a same ad campaign for which the audience analysis system 180 determines reach and frequency of online users, the matched users and unmatched users share a same campaign ID.

Users may match across multiple devices, and the audience analysis system 180 may determine a match based on similar information between one user and another. This may also be used to project or estimate user characteristics, even when the user has not specifically provided that characteristic. Various techniques for estimating the user characteristics are discussed in U.S. patent application Ser. No. 14/808,298, filed Jul. 24, 2015, which is hereby incorporated by reference in its entirety. Thus, in one embodiment the identification module 222 identifies a user and available user characteristics, and may predict further characteristics for a user based on the available user characteristics.

The enrichment module 224 appends user feature data to the matched users to form enriched user data. The user feature data is extracted from the feature data store 260. The enriched user data describes more complete and/or more accurate information about the matched user. For example, the enriched user data also describes the users' characteristics (e.g., demographic and geographic information).

The atomic slicing module 226 generates atomic data units with a specific combination of advertising attributes by separating the ad impression data into the various atomic units. As described above, the atomic data units includes ad information and user information but formed as a combination of different identification attributes. The atomic units with different degrees of granularity makes the data aggregation and computing for determining and predicting reach and frequency of online users more efficient and more convenient. In one embodiment, after the atomic data units are formed, the atomic data units for matched users can be used for model training by the model training module 230. In another embodiment, the atomic data units for both matched users and unmatched users are used for the report generation module 240 to predict reach and frequency of online users as a whole in response to report requests from advertisers 110.

The model training module 230 extracts atomic data units from the aggregated data store 264 as the training data to train and apply reach and frequency estimation models. In one embodiment, multiple reach and frequency estimation models for different reach and frequency purposes with different reach and frequency thresholds are trained to improve accuracy of the trained models. In one embodiment, some of the models are trained for different reach purposes. In another embodiment, some of the models are trained with different probabilistic matches. The reach and frequency estimation models may predict the number of distinct users in the audience for an advertisement. Since the unmatched users have an identity that is unknown, it may be difficult to determine the characteristics of these impressions. In one example, a reach and frequency estimation model extrapolates the frequency of various user characteristics to the unmatched users based on the frequency in the matched users. In other examples, a reach and frequency estimation model predicts the frequency of user characteristics using a known distribution of the characteristics of the referring site. The panel data may be used to verify that the prediction model meets an acceptable prediction threshold, and may be used as a “ground truth” for training the model. One example method of performing this estimation is provided in U.S. patent application Ser. No. 14/866,059, filed Sep. 25, 2015.

Panel data extracted from the panel data stores 270 has confirmed information about online users with higher accuracy and is used to correct the training data. In one embodiment, the models are trained offline.

The report generation module 240 receives report details extracted by the advertiser frontend module 250 and generates report data in responsive to the report details. In one embodiment, the report generation module 240 retrieves relevant atomic data units matching the attributes provided in the report request. To retrieve the relevant atomic data units, the report generation module 240 identifies atomic data units that include identification attributes specified in the request. For example, a report request may specify a publisher and a time span of 12:00-6:00 pm, without specifying a site or type of user device. The atomic units that match any part of the time frame (i.e., 12:00-1:00) and the publisher are relevant to the request. Thus, many atomic data units may be retrieved in response to a request. The report generation module 240 then applies the trained models that are generated from the model training module 230 to predict reach and frequency data for unmatched users. In some examples, the reach and frequency for an atomic data unit is pre-computed and stored with each atomic data unit.

The advertiser frontend module 250 is responsible for communication with outside advertisers 110 and other components in the audience analysis system 180. The advertiser frontend module 250 receives from advertisers 110 report requests and delivers report details to the report generation module 240. The advertiser frontend module 250 also receives report data generated by the report generation module 240 and sends reports including the report data to the advertisers 110.

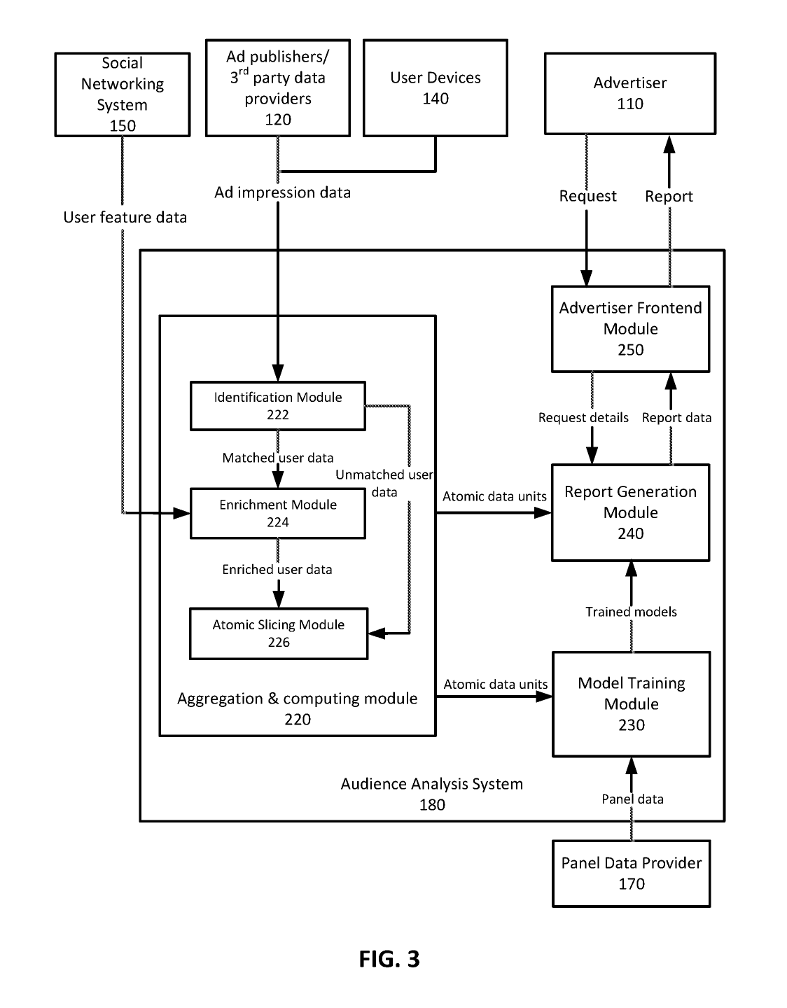

FIG. 3 is an example data flow chart for the audience analysis system 180 to operate in the system environment, according to one embodiment. In the embodiment of FIG. 3, the advertisers 110 sends report requests to the advertiser frontend module 250, asking for reports for reach and frequency information of online users. The ad publishers and/or third party data providers 120 provide real-time ad impression data to the audience analysis system 180, and more specifically to the identification module 222 to identify whether an ad impression can be matched to a user with known user characteristics. The social networking system 150 provides user feature data of its registered users to the audience analysis system 180, and more specifically to enrichment module 224 to generate enriched user data for matched users. The enriched user data is then used by the atomic slicing module 226 to generate atomic data units with different combinations of identification attributes. The atomic slicing module 226 generates atomic data units for both matched and unmatched users. The atomic data unit, in one side, is provided to the model training module 230 to train models based on reach and frequency of matched users. The atomic data unit, in another side, is provided to the report generation module 240 to predict reach and frequency of unmatched users and of all the online users reached by the system 180. Panel data from panel data provider 170 is also provided to the model training module 230 to improve accuracy of the trained models. The report generation module 240 predicts reach and frequency of all the online users including matched users and unmatched users based on atomic data units for the users and multiple trained models. The report data that indicates prediction result for unmatched users and/or determination result for matched users is provided to the advertiser frontend module 250.

The final report presented by the advertiser frontend module 250 is sent to the advertisers 110 in responsive to their report requests.

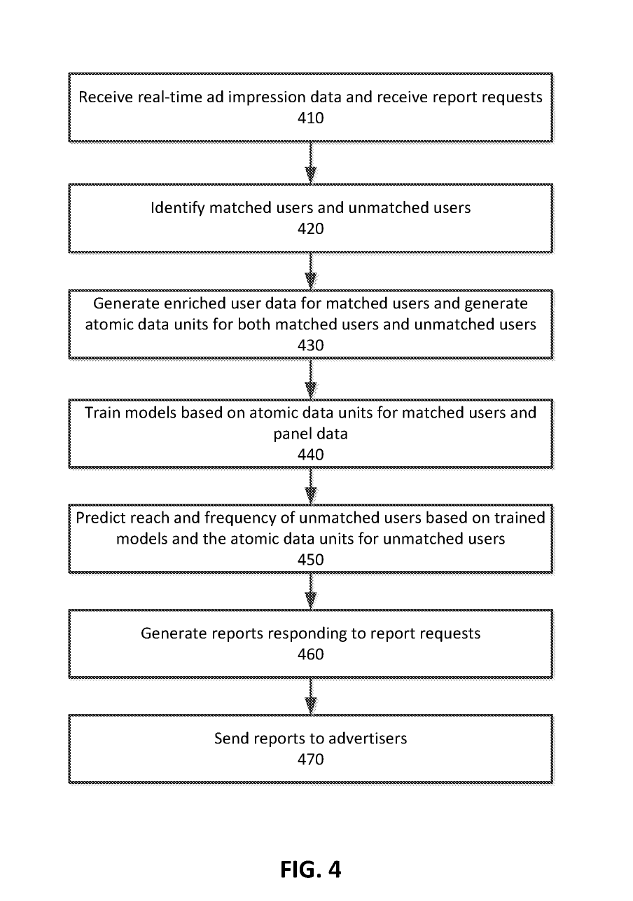

FIG. 4 is a flowchart illustrating a process of reach and frequency determination and prediction, according to one embodiment. In the embodiment of FIG. 4, the audience analysis system 180 receives 410 real-time ad impression data stream. The audience analysis system 180 also receives 410 report requests from advertisers 110. The audience analysis system 180 then identifies 420 matched and unmatched users based on the received ad impression data. The audience analysis system 180 generates 430 enriched user data for matched users and generates 430 atomic data units with specific atomic unit forms for both matched users and unmatched users. The audience analysis system 180 then trains 440 models based on atomic data units for the matched users and panel data. The atomic data units of the matched users include reach and frequency information of the matched users. Panel data is also used to correct user information of the matched users to improve the accuracy of the trained models. The audience analysis system 180 predicts 450 the reach and frequency of unmatched users by applying the trained models to atomic data units of the unmatched users. The audience analysis system 180 may also predict reach and frequency of all the online users that are reached by the system as a whole. The audience analysis system 180 generates 460 reports describing the reach and frequency information of all the online users reached by the audience analysis system including both matched users and unmatched users, responding to the received report requests. The audience analysis system 180 sends 470 final reports to advertisers requesting the reports.

### Additional Configuration Information

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A computer-implemented method comprising:
receiving advertising impression data associated with advertising impression events for an advertising campaign, the advertising impression data identifying one or more identification attributes describing delivery of one or more advertisements associated with the advertising impression events;
identifying a set of matched users from the received advertising impression data for which user feature data associated with the set of matched users is identified and a set of unmatched users for which no user feature data associated with the set of unmatched users is identified;
generating enriched user data for the matched users based on the user feature data of the matched users;
generating, for each of a plurality of combinations of identification attributes, a set of atomic data units describing user information and advertising information associated with the received advertising impression data;
receiving a report request from an advertiser, the report request specifying one or more advertising dimensions of the advertising impression events;
identifying a set of atomic data units associated with a combination of identification attributes matching the one or more advertising dimensions specified in the report request;
determining reach and frequency information of the matched users and the unmatched users, the determined reach and frequency of information including a prediction of characteristics for the unmatched users; and
providing the determined reach and frequency information to the advertiser.

2. The method of claim 1, wherein the one or more advertisements being provided by one or more advertisers, the one or more advertisers including the advertiser from which the report request is received.

3. The method of claim 1, wherein the one or more identification attributes include at least one of user ID, campaign ID, publisher ID, site ID, platform ID, placement ID, device ID and time range.

4. The method of claim 1, wherein identifying a set of matched users from the received advertising impression data comprises identifying the set of matched users with logged-in accounts of a social networking system.

5. The method of claim 1, wherein generating enriched user data for the matched users based on the user feature data of the matched users comprises merging the user feature data into the received advertising impression data for the matched users.

6. The method of claim 1, wherein the user feature data includes demographic information and geographic information of a user, the demographic information including at least one of age, gender, personal hobbies and interest; the geographic information including user location information.

7. The method of claim 1, wherein the set of atomic data units specify a combination of identification attributes, each of the specified identification attributes being filled with a specific value, and each combination of the specified identification attributes with the specific values representing a unique atomic data unit for this combination of identification attributes.

8. The method of claim 7, wherein the atomic data units for the matched users includes information about enriched user data with a specific combination of different identification attributes, the enriched user data including the received advertising impression data and user feature data for the matched users.

9. The method of claim 7, wherein the atomic data units for the unmatched users includes information about the received advertising impression data for the unmatched users with a specific combination of different identification attributes.

10. The method of claim 1, wherein the one or more advertising dimensions includes at least one of campaign ID, publisher ID, site ID, platform ID, placement ID, device ID, time range and characteristics of users, the characteristics of users including demographic information and geographic information.

11. The method of claim 1, wherein the reach and frequency information of the matched users and the unmatched users indicates the number of the matched users and the unmatched users that are reached by the advertiser, and wherein the reach and frequency information of the matched users and the unmatched users indicates the frequency of reaching the matched users and unmatched users by the advertiser.

12. The method of claim 11, wherein reaching the matched users and the unmatched users by the advertiser comprises providing advertisements to the matched users and the unmatched users, the matched users and unmatched users viewing or interacting with the advertisements provided by the advertiser.

13. The method of claim 1, wherein determining reach and frequency information of the matched users and the unmatched users further comprising:
training one or more models based on atomic data units of the matched users;
predicting reach and frequency information of the unmatched users by applying the one or more trained models to the atomic data units of the unmatched users.

14. The method of claim 1, wherein a prediction of characteristics for the unmatched users includes a prediction of demographic information and geographic information for the unmatched users.

15. A system comprising:
a processor configured to execute instructions;
a computer-readable medium containing instructions, the instructions when executed by the processor perform steps:
receiving advertising impression data associated with advertising impression events for an advertising campaign, the advertising impression data identifying one or more identification attributes describing delivery of one or more advertisements associated with the advertising impression events;
identifying a set of matched users from the received advertising impression data for which user feature data associated with the set of matched users is identified and a set of unmatched users for which no user feature data associated with the set of unmatched users is identified;
generating enriched user data for the matched users based on the user feature data of the matched users;
generating, for each of a plurality of combinations of identification attributes, a set of atomic data units describing user information and advertising information associated with the received advertising impression data;
receiving a report request from an advertiser, the report request specifying one or more advertising dimensions of the advertising impression events;
identifying a set of atomic data units associated with a combination of identification attributes matching the one or more advertising dimensions specified in the report request;
determining reach and frequency information of the matched users and the unmatched users, the determined reach and frequency of information including a prediction of characteristics for the unmatched users; and
providing the determined reach and frequency information to the advertiser.

16. The system of claim 15, wherein identifying a set of matched users from the received advertising impression data comprises identifying the set of matched users with logged-in accounts of a social networking system.

17. The system of claim 15, wherein generating enriched user data for the matched users based on the user feature data of the matched users comprises merging the user feature data into the received advertising impression data for the matched users.

18. The system of claim 15, wherein the user feature data includes demographic information and geographic information of a user, the demographic information including at least one of age, gender, personal hobbies and interest; the geographic information including user location information.

19. The system of claim 15, wherein the set of atomic data units specify a combination of identification attributes, each of the specified identification attributes being filled with a specific value, and each combination of the specified identification attributes with the specific values representing a unique atomic data unit for this combination of identification attributes.

20. The system of claim 15, wherein determining reach and frequency information of the matched users and the unmatched users further comprising:
training one or more models based on atomic data units of the matched users;
predicting reach and frequency information of the unmatched users by applying the one or more trained models to the atomic data units of the unmatched users.
